(19) United States
(12) Patent Application Publication
(10) Pub. No.: US 2011/0157243 A1
(43) Pub. Date: Jun. 30, 2011

(54) DISPLAY APPARATUS AND METHOD FOR DRIVING DISPLAY PANEL THEREOF

(75) Inventors: Cheng-Hung Chen, Hsin-Chu (TW); Tsung-Cheng Lin, Hsin-Chu (TW); Hung-Ju Chang, Hsin-Chu (TW)

(73) Assignee: AU OPTRONICS CORP., Hsinchu (TW)

(21) Appl. No.: 12/892,480

(22) Filed: Sep. 28, 2010

(30) Foreign Application Priority Data
Dec. 28, 2009 (TW) 098145322

(51) Int. Cl. G09G 5/10; G09G 5/00

(52) U.S. Cl. 345/690; 345/204

(57) ABSTRACT

A display apparatus and a method for driving a display panel thereof are provided. The display apparatus comprises a display panel and a gate driver. The display panel comprises two gate lines, two source lines, a pixel and two transistors. The pixel is electrically coupled to the two gate lines and the two source lines through the two transistors respectively. The gate driver is for providing a first pulse to one of the gate lines according to a predetermined frequency and providing a second pulse to another one according to the predetermined frequency. An enabling period of the second pulse is behind an enabling period of the first pulse, and a predetermined time interval is existed between a rising edge of the second pulse and a rising edge of the first pulse. The predetermined time interval is longer than a time length of the enabling period of the first pulse.

### BACKGROUND

1. Technical Field

The present invention generally relates to display technology fields and, particularly to a display apparatus and a method for driving a display panel thereof.

2. Description of the Related Art

FIG. 1 is a schematic view of a pixel structure of a conventional display panel. Referring to FIG. 1, the pixel structure primarily comprises a source line 102, a gate line 104, a transistor 106 and a pixel 108. As shown in FIG. 1, a gate electrode of the transistor 106 is electrically coupled to the gate line 104, a source/drain electrode of the transistor 106 is electrically coupled to the source line 102, and another source/drain electrode of the transistor 106 is electrically coupled to the pixel 108.

FIG. 2 is a schematic view of a method for driving the display panel. In FIG. 2, the reference/label SG represents a signal transmitted to the gate line 104, the reference 202 represents a pulse, the reference T represents an enabling period of the pulse 202, and the reference F represents a frame refreshing period. Each pulse 202 is configured for enabling a corresponding pixel 108 and thereby allowing the pixel 108 to be charged through the source line 102, so that a required display data is provided to the pixel 108.

However, the above-mentioned method for driving the display panel is prone to produce a problem of motion blur. For solving the problem, some manufacturers double a frequency for providing the pulses 202. That is, doubling a frame rate to solve the above-mentioned problem. However, the above-mentioned solving method will cause a problem of no enough pixel charging time. For a display panel with a resolution of 1920×1080 and a frame rate of 120 Hz, an actual charging time (that is the enabling period T) of the pixels electrically coupled to each gate line approximately is 7.4 microseconds (μs). However, if the frame rate of the display panel is increased to be 240 Hz, the actual charging time of the pixels electrically coupled to each gate line is reduced to 3.7 μs. Therefore, if a RC delaying time of the signal (that is a resistance-capacitance delaying time) is taken into account, the pixel charging time is so transient and thus seemly not enough.

### BRIEF SUMMARY

The present invention is directed to provide a display apparatus, which can assure an enough pixel charging time while increasing frame rate.

The present invention further is directed to a method for driving a display panel, adapted to the display apparatus.

A display apparatus in accordance with an exemplary embodiment of the present invention comprises a display panel and a gate driver. The display panel comprises a first gate line, a first source line, a second gate line, a second source line, a pixel, a first transistor and a second transistor. The first transistor has a first gate electrode, a first source/drain electrode and a second source/drain electrode. The first gate electrode is electrically coupled to the first gate line, the first source/drain electrode is electrically coupled to the first source line, and the second source/drain electrode is electrically coupled to the pixel. The second transistor has a second gate electrode, a third source/drain electrode and a fourth source/drain electrode. The second gate electrode is electrically coupled to the second gate line, the third source/drain electrode is electrically coupled to the second source line, and the fourth source/drain electrode is electrically coupled to the pixel. The gate driver is electrically coupled to the first gate line and the second gate line and for providing a first pulse to the first gate line according to a predetermined frequency, and further for providing a second pulse to the second gate line according to the predetermined frequency. An enabling period of the second pulse is behind an enabling period of the first pulse, a predetermined time interval is existed between a rising edge of the second pulse and a rising edge of the first pulse, and the predetermined time interval is longer than a time length of the enabling period of the first pulse.

A method for driving a display panel in accordance with an exemplary embodiment of the present invention is provided. The display panel comprises a first gate line, a first source line, a second gate line, a second source line, a pixel, a first transistor and a second transistor. The first transistor has a first gate electrode, a first source/drain electrode and a second source/drain electrode. The first gate electrode is electrically coupled to the first gate line, the first source/drain electrode is electrically coupled to the first source line, and the second source/drain electrode is electrically coupled to the pixel. The second transistor has a second gate electrode, a third source/drain electrode and a fourth source/drain electrode. The second gate electrode is electrically coupled to the second gate line, the third source/drain electrode is electrically coupled to the second source line, and the fourth source/drain electrode is electrically coupled to the pixel. The method comprises steps of: providing a first pulse to the first gate line according to a predetermined frequency; and providing a second pulse to the second gate line according to the predetermined frequency. An enabling period of the second pulse is behind an enabling period of the first pulse, a rising edge of the second pulse is distant from a rising edge of the first pulse with a predetermined time interval, and the predetermined time interval is longer than a time length of the enabling period of the first pulse.

In an exemplary embodiment of the present invention, the predetermined time interval is a half of a time interval between the rising edges of two adjacent the first pulses.

A display panel in accordance with an exemplary embodiment of the present invention is also provided. The display panel comprises a first gate lin, a first source line, a second gate line, a second source line and a pixel, wherein the pixel is electrically coupled to the first gate line and the first source line through a first transistor, and further is electrically coupled to the second gate line and the second source line through a second transistor. Furthermore, the first gate line and the second gate line respectively are for delivering a first pulse and a second pulse to enable the respective first transistor and second transistor and thereby allowing the first source line and the second source line to deliver display data to the pixel for image display, the first pulse and the second pulse are spaced from each other in time sequence.

The present invention employs a specific display panel. Each pixel of the display panel is electrically coupled to two different source lines and the two different gate lines through two transistors respectively. Thus, one of the transistors and the source and gate lines electrically coupled to the transistor can be treated as a group, the other one of the transistors and the source and gate lines electrically coupled to the transistor can be treated as another group, and then the two groups are used for driving the same pixel. In the method for driving the display panel is actually performed, the first pulse is provided to a gate line corresponding to the same pixel according to a predetermined frequency, and the second pulse is provided to another gate line corresponding to the same pixel also according to the predetermined frequency. The enabling period of the second pulse is behind the enabling period of the first pulse, the rising edge of the second pulse and the rising edge of the first pulse have a predetermined time interval existed therebetween, and the predetermined time interval is longer than the time length of the enabling period of the first pulse.

Therefore, for each of the groups, a frequency for providing the pulse is not increased, but for the same pixel, the data refreshing frequency is increased. In other words, the present method for driving the specific display panel not only can increase the frame rate, but also can assure an enough pixel charging time.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a pixel structure of a conventional display panel.

FIG. 2 is a schematic view for illustrating a method for driving the display panel as shown in FIG. 1.

FIG. 3 is a schematic view of a display apparatus in accordance with an exemplary embodiment of the present invention.

FIG. 4 is a schematic view for illustrating a method for driving a display panel as shown in FIG. 3.

FIG. 5 is a schematic view for illustrating a method for driving a display panel in accordance with another exemplary embodiment of the present invention.

FIG. 6 is a schematic view of a display apparatus in accordance with another exemplary embodiment of the present invention.

FIG. 7 is a flow chart of a method for driving a display panel in accordance with an exemplary embodiment of the present invention.

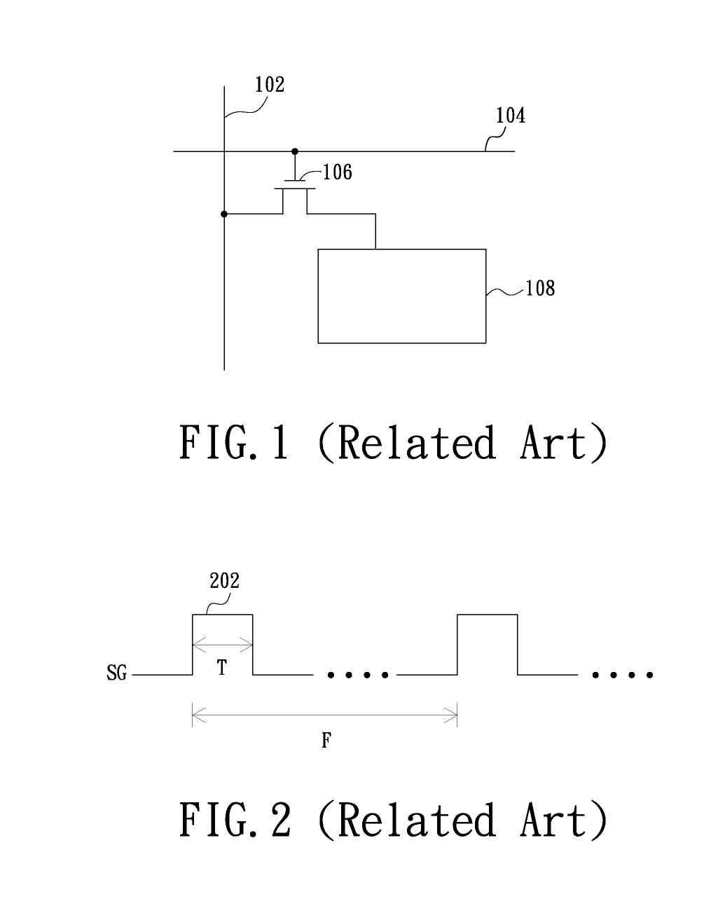

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. Accordingly, the descriptions will be regarded as illustrative in nature and not as restrictive.

### First Exemplary Embodiment

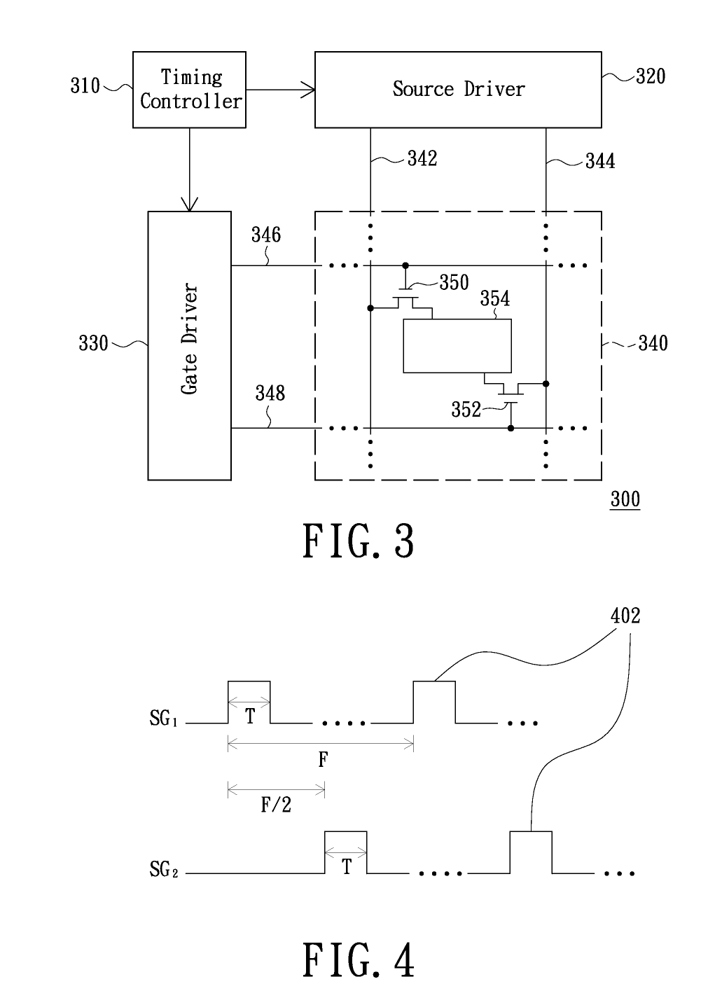

FIG. 3 is a schematic view of a display apparatus in accordance with an exemplary embodiment of the present invention. Referring to FIG. 3, the display apparatus 300 comprises a timing controller 310, a source driver 320, a gate driver 330 and a display panel 340. The timing controller 310 is configured (i.e., structured and arranged) for controlling the operation of the source driver 320 and the gate driver 330, such that the source driver 320 and the gate driver 330 control the display panel 340 to display a required image.

The display panel 340 employs a specific pixel driving structure, and the pixel driving structure comprises source lines 342 and 344, gate lines 346 and 348, and transistors 350 and 352, which all are configured for driving a pixel 354. As shown in FIG. 3, the pixel 354 is electrically coupled to two different source lines and two different gate lines respectively through two transistors. In addition, both of the source lines are electrically coupled to the source driver 320, and both of the gate lines are electrically coupled to the gate driver 330.

FIG. 4 is a schematic view for illustrating a method for driving the display panel 340. In FIG. 4, the reference SG₁ represents a signal outputted from the gate driver 330 to the gate line 346; the reference SG₂ represents a signal outputted from the gate driver 330 to the gate line 348; the reference 402 represents a pulse; the reference T represents an enabling period of the pulse 402; the reference F represents a frame refreshing period, and the reference F/2 represents a half of the frame refreshing period. It should be noted that, the frame refreshing period is a time interval between two rising edges (alternatively, two falling edges of two adjacent pulses 402 according to the actual design) of two adjacent pulses 402 transmitted into a same gate line.

Referring to FIGS. 3 and 4, each of the pulses 402 is configured for enabling the pixel 354, such that the source driver 320 can charge the pixel 354 through the source line 342 or 344 so as to provide a required display data to the pixel 354. From the timing sequence of the pulses as shown in FIG. 4, the gate driver 330 provides the pulses 402 of the signal SG₁ to the gate line 346 according to a certain specific predetermined frequency, and the gate driver 330 also provides the pulses 402 of the signal SG₂ to the gate line 348 according to the specific predetermined frequency similarly.

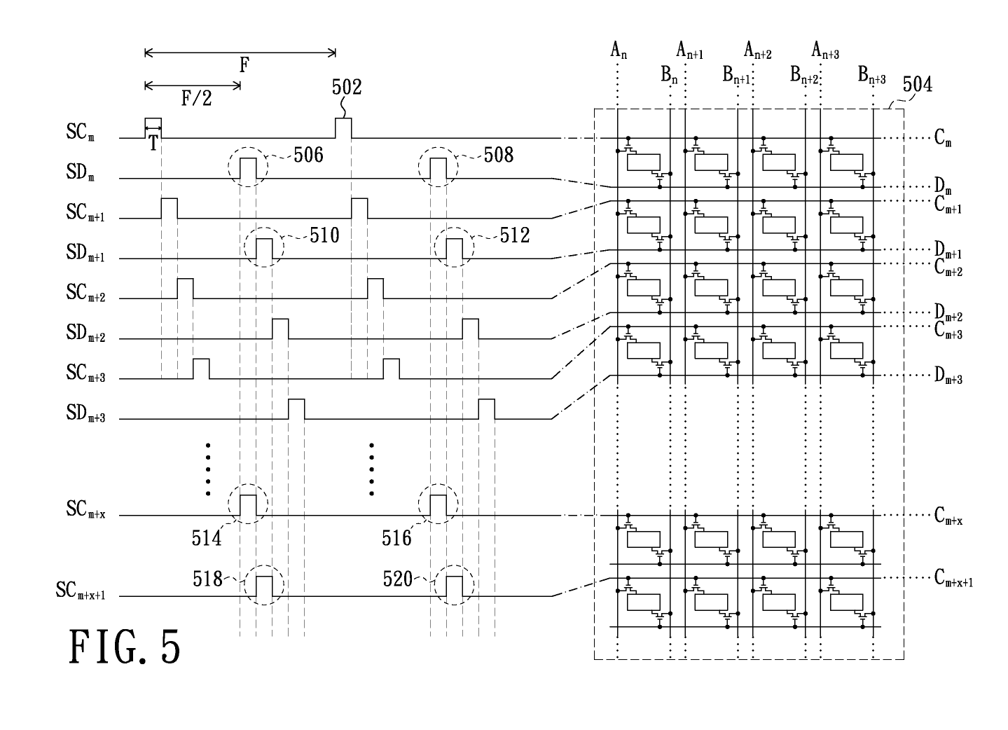

Furthermore, it can be seen from FIG. 4 that, a predetermined time interval is existed between the rising edge of the pulse 402 of the signal SG₂ and the rising edge of the pulse 402 of the signal SG₁ in a same frame refreshing period. The predetermined time interval should be larger than the time length of the enabling period of the pulses 402. More particularly, this exemplary embodiment designs the predetermined time interval to be a half of the time interval between two rising edges of the two adjacent pulses of the signal SG₁. Therefore, in the enabling period of the pulses 402 of the signal SG₁, the source driver 320 can provide a display data in an image corresponding to the pixel 354 to the pixel 354 through the source line 342. Furthermore, in the enabling period of the pulses 402 of the signal SG₂, the source driver 320 can provide another display data in another image corresponding to the pixel 354 to the pixel 354 through the source line 344. Thus, for the pixel 354, the refreshing frequency of the display data thereof can be doubled, i.e., the double of the predetermined frequency. Since in one frame refreshing period F, regardless of the signal SG₁ or the signal SG₂ is only enabled once. Thus, each of the pulses 402 may have a same enabling (or disabling) period with the gate pulse of the conventional driving method using the same frame refreshing period F. Detailed description will be described with reference to FIG. 5.

FIG. 5 is a schematic view for illustrating a method for driving a display panel in accordance with an exemplary embodiment of the present invention. In FIG. 5, the reference 504 represents a display panel; the references Aₙ, Bₙ, Aₙ₊₁, Bₙ₊₁, Aₙ₊₂, Bₙ₊₂, Aₙ₊₃ and Bₙ₊₃ represent source lines; the references Cₘ, Dₘ, Cₘ₊₁, Dₘ₊₁, Cₘ₊₂, Dₘ₊₂, Cₘ₊₃, Dₘ₊₃, Cₘ₊ₓ and Cₘ₊ₓ₊₁ represent gate lines; the references SCₘ, SDₘ, SCₘ₊₁, SDₘ₊₁, SCₘ₊₂, SDₘ₊₂, SCₘ₊₃, SDₘ₊₃, SCₘ₊ₓ and SCₘ₊ₓ₊₁ represent signals outputted to the gate lines Cₘ, Dₘ, Cₘ₊₁, Dₘ₊₁, Cₘ₊₂, Dₘ₊₂, Cₘ₊₃, Dₘ₊₃, Cₘ₊ₓ and Cₘ₊ₓ₊₁ in sequence; the reference 502 represents a pulse; the reference T represents an enabling period of the pulse 502; the reference F represents a frame refreshing period, and the reference F/2 represents a half of the frame refreshing period.

As shown in FIG. 5, each of the signals outputted to the gate lines provides the pulses 502 to a corresponding gate line according to a same predetermined frequency. If the resolution of the display panel 504 is assumed to be 1920×1080 and each of the signals outputted to the gate lines provides the pulses 502 to the corresponding gate line according to the predetermined frequency of 120 Hz, the actual charging time (that is the enabling period T) of the pixels electrically coupled to each of the gate lines approximately is 7.4 μsc. Thus the actual pixel charging time is same to that of the display panel with the frame rate of 120 Hz in the prior art, and the frame rate of the present display panel 504 is increased to 240 Hz. From the above description it can be seen that, the present invention not only keeps the original pixel charging time of the display panel, but also doubles the frame rate of the display panel, compared with the conventional method of directly doubling the frequency for providing the pulse.

It should be noted that, the driving method of the exemplary embodiment may occur overlap of the enabling periods of the pulses, which will be described with reference to FIG. 5. As shown in FIG. 5, the enabling period of the pulse 502 of the signal SCₘ₊ₓ overlaps the enabling period of the pulse 502 of the signal SDₘ. That is, the enabling periods of the two pulses 502 indicated by the references 514 and 506 are overlapped as well as the enabling periods of the two pulses 502 indicated by the references 516 and 508. In addition, the enabling period of the pulse 502 of the signal SCₘ₊ₓ₊₁ would be overlapped with the enabling period of the pulse 502 of the signal SDₘ₊₁. That is, the enabling periods of the two pulses 502 indicated by the references 518 and 510 are overlapped as well as the enabling periods of the two pulses 502 indicated by the references 520 and 512. It means that the pixels in such two pixel rows would be enabled simultaneously. However, it will not cause the pixels to be loaded with wrong display data. For example the signals SDₘ and SCₘ₊ₓ, when the two signals simultaneously transmit the pulses 502 respectively to the gate lines Dm and Dm+x, the pixels electrically coupled to the two gate lines are enabled simultaneously. However, at the moment, the pixels electrically coupled to the gate line Dᵣ, are provided with the corresponding display data through the source lines Bₙ, Bₙ₊₁, Bₙ₊₂ and Bₙ₊₃, and the pixels electrically coupled to the gate line Cₘ₊ₓ are provided with the corresponding display data through the source lines Aₙ, Aₙ₊₁, Aₙ₊₂ and Aₙ₊₃, thus it will not load the wrong display data into the pixels.

Referring to FIGS. 3 and 4 again, although the exemplary embodiment defines the predetermined time interval is the half of the time interval between the rising edges of the two adjacent pulses of the signal SG₁, the present invention is not limited in this. It is understood for the persons skilled in the art that, the predetermined time interval may be appropriately increased or decreased. It should be noted that, another type of source driver 320 may be employed to solve the problem of the color washout of the display panel 340 at a wide viewing angle, which will be further described with reference to FIGS. 3 and 4. Referring to FIGS. 3 and 4, in the enabling period of the pulses 402 of the signal SG₁, the source driver 320 may provide a first display data in an image corresponding to the pixel 354 to the pixel 354 through the source line 342. In the enabling period of the pulse 402 of the signal SG₂, the source driver 320 may provide a second display data in the same image corresponding to the pixel 354 to the pixel 354 through the source line 344. It should be noted that, the luminance average value of the two display data should be a predetermined luminance value of the display data in the image corresponding to the pixel 354.

### Second Exemplary Embodiment

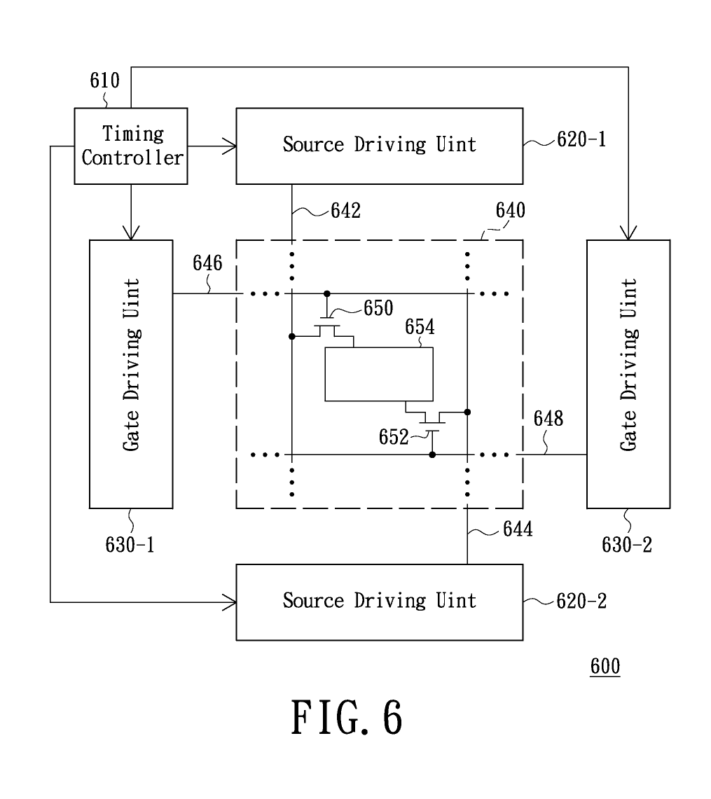

FIG. 6 is a schematic view of a display apparatus in accordance with another exemplary embodiment of the present invention. Referring to FIG. 6, the display apparatus 600 further comprises a display panel 640 besides a timing controller 610, a source driver composed of source driving units 620-1 and 620-2, and a gate driver composed of gate driving units 630-1 and 630-2. The timing controller 610 is configured for controlling the source driving units 620-1 and 620-2 as well as the gate driving units 630-1 and 630-2, such that the two source driving units and the two gate driving units control the display panel 640 to display the required image.

A pixel structure of the display panel 640 is same to that of the display panel 340 of the first exemplary embodiment, but the electrical coupling method of the source lines and the gate lines is different. In FIG. 6, the source lines 642 and 644 are electrically coupled to the source driving units 620-1 and 620-2 respectively, and the gate lines 646 and 648 are electrically coupled to the gate driving units 630-1 and 630-2 respectively. In this exemplary embodiment, the gate driving unit 630-1 is configured for providing pulses to the gate line 646 according to a predetermined frequency, and the gate driving unit 630-2 is configured for providing pulses to the gate line 648 according to the predetermined frequency. The source driving unit 620-1 is configured for providing display data to the source line 642, and the source driving unit 620-2 is configured for providing display data to the source line 644.

The exemplary embodiment mainly describes the different implementation mode of the gate driver and the source driver. The operation of the source driving units 620-1 and 620-2 and the gate driving units 630-1 and 630-2 may be deduced from the first exemplary embodiment for the persons skilled in the art, and thus will not be described herein.

From the exemplary embodiment, it is understood for the persons skilled in the art that the present invention may change the source driver of FIG. 6 to be the source driver 620 of the first exemplary embodiment, or change the gate drive of FIG. 6 to be the gate driver 630 of the first exemplary embodiment, the present invention still can be implemented by suitably changing the electrical coupling method of the gate lines and the source lines.

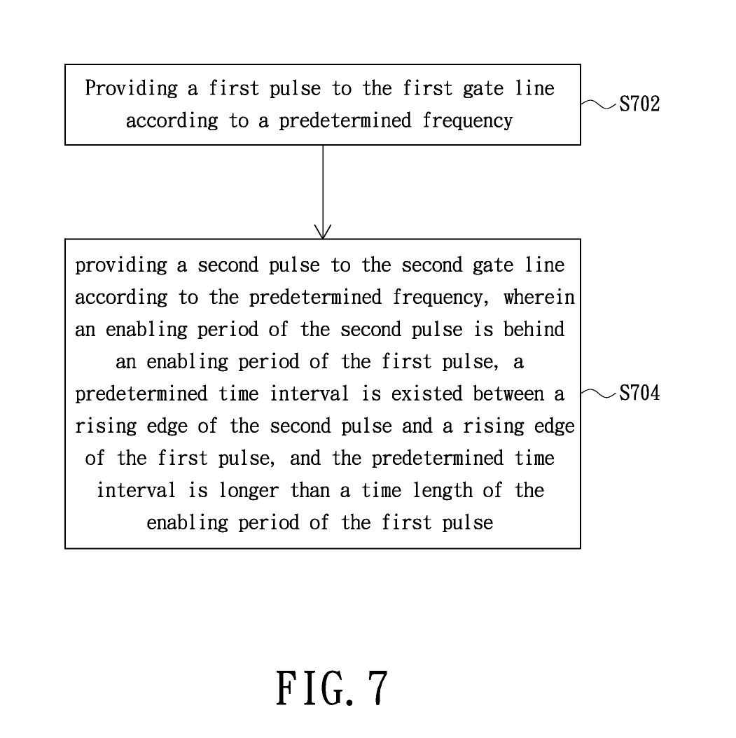

From the above exemplary embodiments, a basic operation of the present invention may be concluded and will be described with reference to FIG. 7. FIG. 7 is a primary flow chart of a method for driving a display panel in accordance with an exemplary embodiment of the present invention. The display panel comprises a first gate line, a first source line, a second gate line, a second source line, a pixel, a first transistor and a second transistor. The first transistor comprises a first gate electrode, a first source/drain electrode and a second source/drain electrode. The first gate electrode is electrically coupled to the first gate line, the first source/drain electrode is electrically coupled to the first source line, and the second source/drain electrode is electrically coupled to the pixel. The second transistor comprises a second gate electrode, a third source/drain electrode and a fourth source/drain electrode. The second gate electrode is electrically coupled to the second gate line, the third source/drain electrode is electrically coupled to the second source line, and the fourth source/drain electrode is electrically coupled to the pixel. The method for driving the display panel comprises steps of: providing a first pulse to the first gate line according to a predetermined frequency (as shown in step S702); and providing a second pulse to the second gate line according to the predetermined frequency, wherein an enabling period of the second pulse is behind an enabling period of the first pulse, a predetermined time interval is existed between a rising edge of the second pulse and a rising edge of the first pulse, and the predetermined time interval is longer than a time length of the enabling period of the first pulse (as shown in step S704).

In summary, the present invention employs a specific display panel. Each pixel of the display panel is electrically coupled to two different source lines and two different gate lines through two respective transistors. Thus, one transistor and the source and gate lines electrically coupled to the transistor can be treated as a group, the other one transistor and the source and gate lines electrically coupled to the transistor can be treated as another group, and then the two groups are used for driving a same pixel. In the actual application of the driving method, the first pulse is provided to a gate line corresponding to the same pixel according to the predetermined frequency, and the second pulse is provided to another gate line corresponding to the same pixel according to the predetermined frequency. The enabling period of the second pulse is behind the enabling period of the first pulse, and a predetermined time interval is defined between the rising edge of the second pulse and the rising edge of the first pulse. The predetermined time interval is longer than the time length of the enabling period of the first pulse.

Therefore, for each of the groups, the frequency for providing the pulse is not increased, but for the same pixel, the frame rate is increased. In other words, the present method for driving the specific display panel not only can increase the frame rate, but also can assure the enough pixel charging time.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A display apparatus, comprising:
a display panel comprising:
a first gate line;
a first source line;
a second gate line;
a second source line;
a pixel;
a first transistor having a first gate electrode, a first source/drain electrode and a second source/drain electrode, the first gate electrode being electrically coupled to the first gate line, the first source/drain electrode being electrically coupled to the first source line, and the second source/drain electrode being electrically coupled to the pixel; and
a second transistor having a second gate electrode, a third source/drain electrode and a fourth source/drain electrode, the second gate electrode being electrically coupled to the second gate line, the third source/drain electrode being electrically coupled to the second source line, and the fourth source/drain electrode being electrically coupled to the pixel; and
a gate driver electrically coupled to the first gate line and the second gate line, for providing a first pulse to the first gate line according to a predetermined frequency, and for providing a second pulse to the second gate line according to the predetermined frequency,
wherein an enabling period of the second pulse is behind an enabling period of the first pulse, a rising edge of the second pulse is distant from a rising edge of the first pulse with a predetermined time interval, and the predetermined time interval is longer than a time length of the enabling period of the first pulse.

2. The display apparatus as claimed in claim 1, wherein the predetermined time interval is a half of a time interval between the rising edges of two adjacent the first pulses.

3. The display apparatus as claimed in claim 1, wherein the gate driver comprises:
a first gate driving unit electrically coupled to the first gate line, for providing the first pulse to the first gate line according to the predetermined frequency; and
a second gate driving unit electrically coupled to the second gate line, for providing the second pulse to the second gate line according to the predetermined frequency.

4. The display apparatus as claimed in claim 1, further comprising:
a source driver electrically coupled to the first source line and the second source line, for providing display data to the first source line and the second source line.

5. The display apparatus as claimed in claim 4, wherein the source driver provides a display data in a first image corresponding to the pixel to the first source line in the enabling period of the first pulse, and provides a display data in a second image corresponding to the pixel to the second source line in the enabling period of the second pulse.

6. The display apparatus as claimed in claim 4, wherein the source driver provides a first display data in an image corresponding to the pixel to the first source line in the enabling period of the first pulse, and provides a second display data in the image corresponding to the pixel to the second source line in the enabling period of the second pulse.

7. The display apparatus as claimed in claim 6, wherein a luminance average value of the first display data and the second display data is a predetermined luminance value of a display data in the image corresponding to the pixel.

8. The display apparatus as claimed in claim 4, wherein the source driver comprises:
a first source driving unit electrically coupled to the first source line, for providing display data to the first source line; and
a second source driving unit electrically coupled to the second source line, for providing display data to the second source line.

9. The display apparatus as claimed in claim 8, wherein the first source driving unit provides the display data in a first image corresponding to the pixel to the first source line in the enabling period of the first pulse, and the second source driving unit provides the display data in a second image corresponding to the pixel to the second source line in the enabling period of the second pulses.

10. The display apparatus as claimed in claim 8, wherein the first source driving unit provides a first display data in an image corresponding to the pixel to the first source line in the enabling period of the first pulse, and the second driving unit provides a second display data in the image corresponding to the pixel to the second source line in the enabling period of the second pulse.

11. The display apparatus as claimed in claim 10, wherein a luminance average value of the first display data and the second display data is a predetermined luminance value of a display data in the image corresponding to the pixel.

12. A method for driving a display panel, wherein the display panel comprises a first gate line, a first source line, a second gate line, a second source line, a pixel, a first transistor and a second transistor, the first transistor having a first gate electrode, a first source/drain electrode and a second source/drain electrode, the first gate electrode being electrically coupled to the first gate line, the first source/drain electrode being electrically coupled to the first source line, and the second source/drain electrode being electrically coupled to the pixel, the second transistor having a second gate electrode, a third source/drain electrode and a fourth source/drain electrode, the second gate electrode being electrically coupled to the second gate line, the third source/drain electrode being electrically coupled to the second source line, and the fourth source/drain electrode being electrically coupled to the pixel; the method comprising:
providing a first pulse to the first gate line according to a predetermined frequency; and
providing a second pulse to the second gate line according to the predetermined frequency,
wherein an enabling period of the second pulse is behind an enabling period of the first pulse, a predetermined time interval is existed between a rising edge of the second pulse and a rising edge of the first pulse, and the predetermined time interval is longer than a time length of the enabling period of the first pulse.

13. The method as claimed in claim 12, wherein the predetermined time interval is a half of a time interval between the rising edges of two adjacent the first pulses.

14. The method as claimed in claim 12, further comprising:
providing a display data in a first image corresponding to the pixel to the first source line in the enabling period of the first pulse; and
providing display data in a second image corresponding to the pixel to the second source line in the enabling period of the second pulse.

15. The method as claimed in claim 12, further comprising:
providing a first display data in an image corresponding to the pixel to the first source line in the enabling period of the first pulse; and
providing a second display data in the image corresponding to the pixel to the second source line in the enabling period of the second pulse.

16. The method as claimed in claim 15, wherein a luminance average value of the first display data and the second display data is a predetermined luminance value of a display data in the image corresponding to the pixel.

17. A display panel, comprising:
a first gate line;
a first source line;
a second gate line;
a second source line;
a pixel;
wherein the pixel is electrically coupled to the first gate line and the first source line through a first transistor, and further is electrically coupled to the second gate line and the second source line through a second transistor, and
wherein the first gate line and the second gate line respectively are for delivering a first pulse and a second pulse to enable the respective first transistor and second transistor and thereby allowing the first source line and the second source line to deliver display data to the pixel for image display, the first pulse and the second pulse are spaced from each other in time sequence.
